(19) United States
(12) Patent Application Publication
(10) Pub. No.: US 2026/0160741 A1
(43) Pub. Date: Jun. 11, 2026

(54) ANALYTICAL APPARATUS FOR DETERMINING THE CONCENTRATION OF AN ANALYTE AND CORRESPONDING METHOD

(71) Applicant: Endress+Hauser Conducta GmbH+Co. KG, Gerlingen (DE)

(72) Inventors: Christian Cramer, Stuttgart (DE); Eva-Maria Petat, Stuttgart (DE); Maik Röder, Benningen (DE); Kay Steen, Leinfelden-Echterdingen (DE)

(21) Appl. No.: 19/414,459

(22) Filed: Dec. 10, 2025

(30) Foreign Application Priority Data
Dec. 10, 2024 (DE) 10 2024 136 951.5

(51) Int. Cl. G01N 31/12

(52) U.S. Cl. CPC G01N 31/12

(57) ABSTRACT

An analytic apparatus for determining the concentration of an analyte in a liquid sample includes a dosing apparatus for dosing the sample into a high-temperature digestion apparatus for digesting the sample and forming a gas mixture, wherein the high-temperature digestion apparatus includes a gas supply line for supplying a carrier gas, wherein the high-temperature digestion apparatus is connected to an analysis chamber via a gas outlet, wherein a pressure sensor is arranged upstream from the analysis chamber within the gas supply line, wherein a first flow rate sensor is arranged upstream from the analysis chamber and is coupled to the control unit, and wherein a second flow rate sensor is arranged downstream from the analysis chamber and is coupled to the control unit for further processing of the flow rate signals output by the flow rate sensor.

The present application is related to and claims the priority benefit of German Patent Application No. 10 2024 136 951.5, filed December 10, 2024, the entire contents of which are incorporated herein by reference.

### TECHNICAL FIELD

The present disclosure relates to an analytical apparatus for determining the concentration of an analyte and a corresponding method.

### BACKGROUND

Dosing liquids into a reaction vessel plays a role in analytical technology, for example. In such applications, analytes or reagents often need to be dosed. The dosing of liquids is to generally fulfill the aim of introducing a defined volume of a substance into the reaction vessel.

An important application in wastewater analysis, for example, in which the analyte has to be dosed into a reaction vessel, is the determination of the carbon content and/or the nitrogen content in wastewater, for example, the TOC (total organic carbon) or the TNb (total bound nitrogen). In known methods for determining these parameters, a liquid sample of a small volume, for example, a few 100 µl, is supplied into a reaction vessel of the high-temperature digestion apparatus. In the reaction vessel, which is formed, for example, by a high-temperature reactor designed as a pyrolysis tube, the organic components are thermally broken down into CO₂, and the nitrogen-containing components into nitrogen oxide (NOx). The abbreviation NOx in this case stands for a mixture of nitrogen oxides with nitrogen in various oxidation states that however has NO as the main component. During the reaction in the high-temperature reactor, a gas mixture arises which, in addition to CO₂ and NOx, contains gaseous H₂O and possibly other pyrolysis and reaction products of substances in the sample. The gas mixture is transported through a cooler with a water separator, a gas filter and an analysis unit with the help of a carrier gas permanently flowing through the reaction vessel that usually also supplies the necessary reaction oxygen. The quantity of the arising CO₂ or NOx is determined, for example, by infrared measurement or by chemiluminescence measurement, and from this value, the TOC or TNb content of the liquid sample is determined.

The temperatures prevailing in the high-temperature digestion apparatus during operation lie significantly above the boiling point of the dosed liquid sample. During TOC or TNb determination, the temperature in the interior of the reaction vessel is usually between approximately 650 °C and 1300 °C, depending on whether the digestion of the sample is additionally supported by a catalyst. In contact with the wall of the reaction vessel or other surfaces present within the reaction vessel, the sample reaches the boiling point or the reaction temperature required for reaction with the oxygen contained in the carrier gas within a very short time. A sample dosed into the reaction vessel therefore passes into the gas phase immediately after being dosed into the reaction vessel by evaporation and/or by the formation of gaseous reaction products.

There are some disadvantages with the existing systems. For example, it cannot be ensured whether the sample has actually been injected into the oven. In addition, the sample volume of the injection is only theoretically known. Furthermore, the state of the entire system is not known, for example, whether there is any contamination. Leaks in the system cannot be detected.

### SUMMARY

It is therefore the object of the present disclosure to provide a method for operating an analytical apparatus which overcomes the disadvantages of the above-described methods. In particular, a method for operating an analytical apparatus is to be specified that ensures reliable monitoring of the dosage of the liquid sample on the one hand and reliable measuring mode with high accuracy on the other.

The object is achieved by an analytical apparatus for determining the concentration of an analyte, in particular of an oxidizable component, in a liquid sample which comprises a dosing apparatus, in particular comprising a pump, for dosing the liquid sample into a high-temperature digestion apparatus for digesting the liquid sample and forming a gas mixture, wherein the high-temperature digestion apparatus has a reaction vessel with a liquid inlet for the liquid sample and a gas supply line for supplying a carrier gas, and is connected to an analysis chamber via a gas outlet; wherein during operation of the device, a gas stream of a carrier gas forms between the gas inlet and the analysis chamber; wherein a pressure sensor is arranged upstream from the analysis chamber within the gas supply line in the direction of the gas stream, wherein the pressure sensor is coupled to a control unit for further processing the pressure signals output by the pressure sensor; wherein a first flow rate sensor is arranged upstream from the analysis chamber in the direction of the gas stream, in particular within the gas supply line for supplying the carrier gas, wherein the first flow rate sensor is coupled to the control unit for further processing of the flow rate signals output by the flow rate sensor; and wherein a second flow rate sensor is arranged downstream from the analysis chamber in the direction of the gas stream, wherein the second flow rate sensor is coupled to the control unit for further processing of the flow rate signals output by the flow rate sensor.

Since the temperature of the reaction vessel lies above the boiling point of the dosed liquid, the liquid transitions into the gas phase immediately after entering the reaction vessel by evaporation and/or by the formation of gaseous reaction products. In particular, upon contact with a surface within the reaction vessel, for example, the inner wall of the reaction vessel, a surface of an insert arranged in the reaction vessel or on a catalyst bed, the heat transfer to the sample occurs particularly quickly, e.g., within less than 0.3 s, in particular within less than 0.1 s, so that the sample transitions into the gas phase immediately after contact with the surface. An insert can be provided within the reaction vessel which contains bulk material, on the surface of which such rapid heat transfer to the impinging sample can take place. The transition of the sample into the gas phase leads to a short-term increase in pressure, hereinafter referred to as pressure surge or pressure pulse, within the reaction vessel.

The pressure signals are recorded by means of a pressure sensor which is arranged within the gas stream. A pressure sensor arranged within the gas stream is understood to be a pressure sensor that is, in principle, arranged at any position along the flow path of the gas stream. This position is preferably chosen outside the reaction vessel, since lower temperatures prevail there than inside the reaction vessel. Flow resistances in the course of the gas stream lead to the fact that pressure changes within the reaction vessel can also be detected by a pressure sensor arranged outside the reaction vessel within the gas stream, namely by a pressure sensor arranged within a supply line for the gas stream into the reaction vessel.

The system allows for early recognition of maintenance needs (predictive maintenance) through pressure and flow rate measurements. By means of differential flow rate measurement, leaks can be recognized early. The system ensures that samples are injected into the oven. However, by measuring the maximum pressure and integrating the pressure over time, it can be evaluated whether the desired quantity has entered the oven.

In one embodiment, the analytical apparatus comprises a data processing unit, wherein the data processing unit controls all functions of the analytical apparatus and in particular controls or carries out the above-described method for determining the concentration of an analyte in a liquid sample. The central data processing unit controls in particular the dosing apparatus for adding the liquid sample and evaluates the signals of the detection device arranged in the analysis chamber. In particular, the central data processing unit calculates the analysis result and outputs it. However, it can also be designed as a separate data processing unit.

Between the gas outlet of the reaction vessel and the analysis chamber, a filter unit for removing solid particles from the gas stream as well as a condensation unit for condensing water from the gas stream can be arranged in the flow path of the gas stream.

The analyzer uses changes in pressure and flow rate behavior for state recognition and proactive maintenance (often referred to as “predictive maintenance”). By means of the differential flow rate measurement, leaks can be recognized early. The system recognizes whether samples are injected into the oven and whether the desired quantity is reached. It also allows for early recognition of overloading of the catalyst bed with non-combustible residues from the sample.

One embodiment provides for the carrier gas to be introduced continuously.

One embodiment provides for the sample to be dosed into the oven in batches, in particular every 5 to 10 minutes.

The object is further achieved by a method for determining the TOC content of a liquid sample with an analytical apparatus as described above.

One embodiment provides that a leak is inferred from the difference between the determined flows.

One embodiment provides that it is determined from the pressure measurement whether any sample reaches the oven at all.

One embodiment provides that the sample quantity is determined and controlled from the pressure measurement, wherein incorrect dosing, in particular insufficient quantities of sample, are detected.

To ascertain the quantity of the quantity dosed into the reaction vessel, a current pressure signal can be ascertained from the sequence of pressure signals by a comparison with a base pressure value, a pressure change associated with the current pressure signal, and the pressure change can be compared with a predetermined threshold value, and on the basis of a result of the comparison, it can be discerned whether the pressure change corresponds to a pressure surge caused by dosing the sample into the reaction vessel.

In so doing, the base pressure value can be formed by calculating an average value, in particular by calculating a moving average value, using at least two pressure signals preceding the current pressure signal in the sequence of pressure signals. For example, the base pressure value at the beginning of the method can be set to the pressure prevailing in the reaction vessel before the start of sample dosing. During dosing of the liquid, successive pressure signals are recorded, and the base pressure value is adjusted by calculating a moving average value while taking into account the most recent pressure signals in the sequence.

Since the base pressure value substantially corresponds to the “background pressure” prevailing in the reaction vessel, it represents the “zero line” or “base line” of the pressure curve.

One embodiment provides that a base pressure value is ascertained from the pressure measurement, in particular by averaging over a certain period of time, and from a change in the base pressure value, a fault in the analytical apparatus is inferred, for example, contamination.

One embodiment provides that an inference is made about possible maintenance based on the pressure curve and the flow rate measurement curves.

### BRIEF DESCRIPTION OF THE DRAWINGS

The present disclosure is explained in more detail with reference to the following figures:

FIG. 1 shows an analytical apparatus according to the present disclosure in a schematic representation;

FIG. 2 schematically shows a course of a carrier gas;

FIG. 3 shows CO₂ signal at the top and a measured oven pressure at the bottom;

FIG. 4a shows CO₂ signals at the top and the measured flow rate at a second flow rate sensor at the bottom;

FIG. 4b shows a CO₂ signal at the top and measured flow rates at the first and second flow rate sensors at the bottom;

FIG. 5 shows a measured flow rate of the two flow rate sensors; and

FIG. 6 shows a pressure curve when the oven becomes salinized.

In the figures, the same features are labeled with the same reference signs.

### DETAILED DESCRIPTION

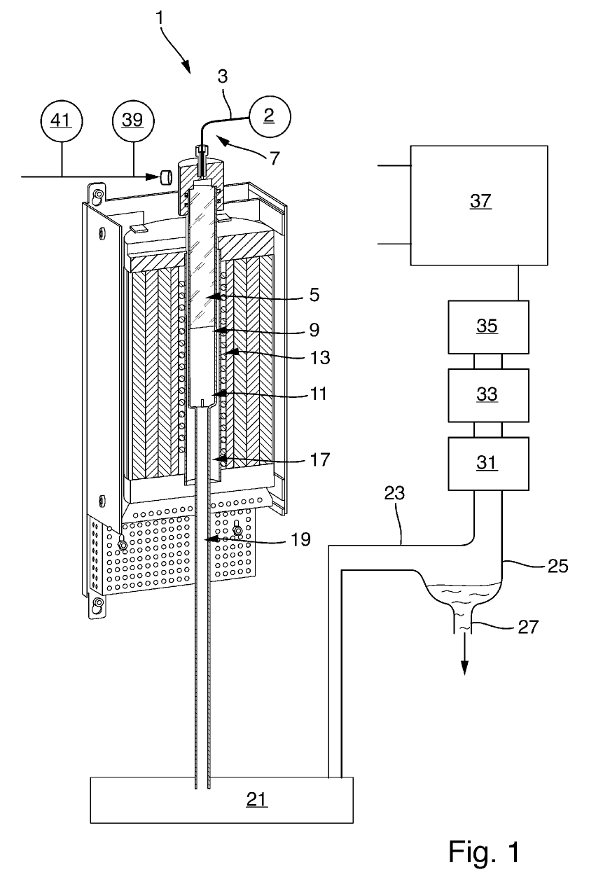

In the analytical apparatus 1 shown in FIG. 1 for determining, for example, the TOC or TNb content of a liquid sample, for example, a wastewater sample, the sample is supplied from a dosing apparatus 2, shown only schematically via an injection nozzle 3 to a reaction vessel 5 embodied, for example, as a pyrolysis tube. At the same time, an oxygen-containing carrier gas is supplied to the reaction vessel 5 via a further supply line 7. To avoid incorrect determinations, the carrier gas must be chemically pure, that is, at least free of CO₂ or other carbon-containing chemical compounds.

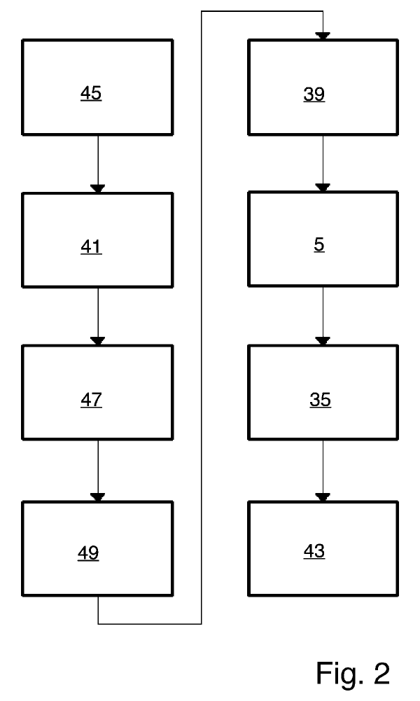

FIG. 2 shows in this regard the course of the carrier gas. Before the carrier gas is recorded in terms of pressure (see below, pressure sensor 39), it passes through a filter 45, a first flow rate sensor 41 and, a CO₂ removal unit 47. The carrier gas is pumped through the analytical apparatus 1 by a pump 49. Alternatively, compressed gas (e.g., nitrogen, artificial air, oxygen or compressed air) can be used; in the following, the pump is assumed. Subsequently, the carrier gas with the sample to be analyzed then enters a high-temperature digestion apparatus with an oven (reaction vessel 5, see below), the analysis chamber 35 and a second flow rate sensor 43.

In the example shown in FIG. 1, the reaction vessel 5 contains an insert 9 which contains a catalyst 11 which supports the reaction of the liquid sample with the oxygen-containing carrier gas. In order to support the reaction of the liquid sample with the carrier gas, a correspondingly high internal temperature of the reaction vessel 5 could also be set. The temperature of the reaction vessel 5 can be adjusted by means of a heating device 13 surrounding the reaction vessel 5. Located in the region of the insert 9 is the reaction zone in which a temperature between 650 °C and 1300 °C prevails during operation. Optionally, bulk material (not shown) can be accommodated within the reaction zone in the insert 9, which is retained, for example, by the sieve bottom of the insert 9 provided with passage channels. Given contact between a surface in the interior of the reaction vessel 5 with, for example, the surface of the catalyst 11 or the bulk material, the liquid sample to be analyzed heats up to the boiling or reaction temperature within a very short time, namely within a few tenths of a second, in particular within less than 0.4 s, and transitions into the gas phase. When the liquid sample is injected into the hot oven, the sample evaporates suddenly (volume expansion), which creates a pressure surge that can also be measured as an increase in the volume/mass flow.

The described method is carried out in a permanent measuring mode, also called continuous measuring mode. In so doing, the carrier gas is supplied continuously.

The sample liquid is dosed in a batch method, in which a specific volume, typically 100 µl to 1500 µl, of the sample liquid is digested in the reaction vessel 5. The quantity is quickly dosed into the oven as a sample jet. The quantity of oxidation product of the analyte contained in the carrier gas stream leaving the reaction vessel 5 accordingly depends on both the volume of the dosed sample liquid as well as on the concentration of the analyte in the sample liquid.

The entire flow path of the carrier gas is sealed from the environment so that no gas can escape from the analytical apparatus 1. The gas stream exits the analytical apparatus 1 through a gas outlet (not shown) of the analysis chamber 35. Alternatively, the carrier gas can also be supplied back to the analytical apparatus 1 via the gas supply line 7 in a circulation process. The components of the analytical apparatus 1 downstream from the reaction vessel 5 provide a flow resistance to the gas stream. In this way, it is possible to detect pressure changes in the interior of the reaction vessel 5 also in the gas supply line 7, i.e., a pressure change inside the reaction vessel 5 caused, for example, by the transition of a sample quantity into the gas phase causes a correlated pressure change in the gas supply line 7. A pressure sensor 39 arranged in the gas supply line 7 records the pressure prevailing in the gas supply line 7 and converts it into a, for example, proportional electrical signal dependent on this pressure, also referred to as a pressure signal. From a sequence of such pressure signals, pressure changes in reaction vessel 5 can be inferred. The pressure sensor 39 is connected on the output side to an input of the data processing unit 37 for transmitting pressure signals. Since the entire flow path of the carrier gas is sealed from the environment, the pressure sensor 39 for recording the pressure prevailing within the reaction vessel 5 can in principle be provided at any position along the flow path, for example, in the region of the gas outlet 19 or within the filter unit 21. However, the position within the supply line 7 is particularly advantageous and demanding, since the temperature there is still low, for example, in the range of room temperature.

The sample quantity can be determined and controlled by measuring the pressure. In so doing, in particular, incorrect dosing, for example, too small a quantity of sample, is detected. Accordingly, it is then possible to respond thereto and, if necessary, another quantity of sample can be dosed.

The analytical apparatus 1 further comprises the first and second flow rate sensors 41, 43. The first flow rate sensor 41 is arranged in the immediate vicinity of the pressure sensor 39, i.e., in the supply line 7, i.e., at the inlet. The second flow rate sensor 43 is arranged downstream from the analysis chamber 35 in the flow rate of the carrier gas, i.e., at the outlet.

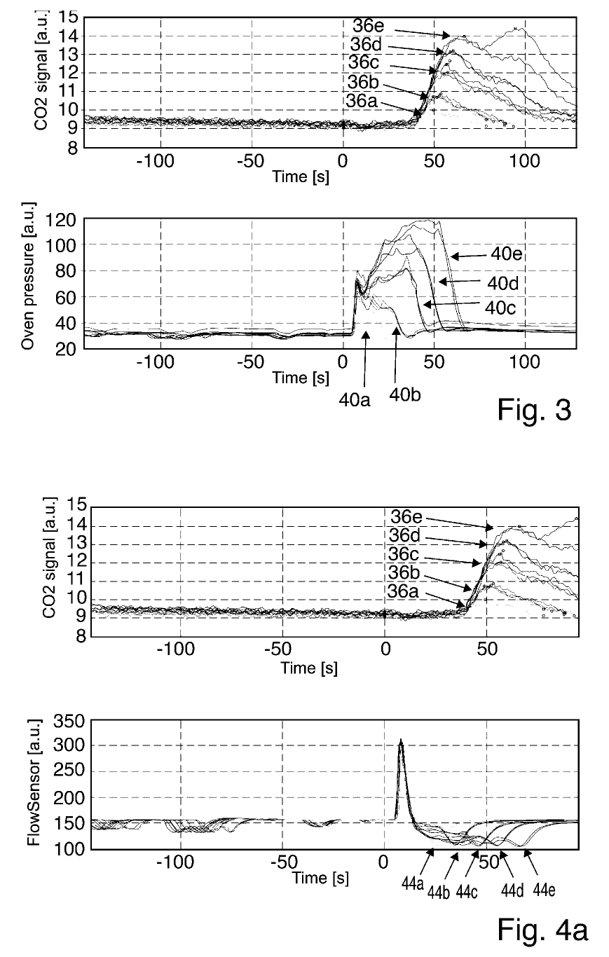

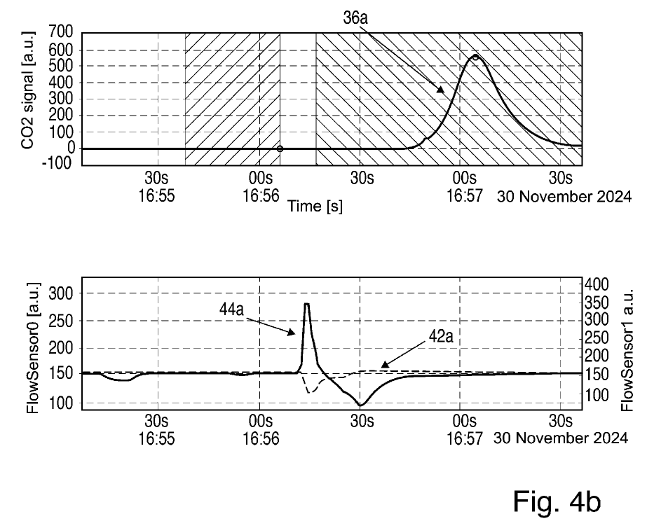

In the top illustration, FIG. 3 shows the CO₂ signal (ascertained in the analysis chamber 35 and by the data processing unit 37) and the measured pressure at the bottom. FIG. 4a shows CO₂ signals at the top, and the measured flow rate at the second flow rate sensor 41 at the bottom. FIG. 4b shows a CO₂ signal at the top, and the measured flow rate at the first and second flow rate sensor 41, 43 at the bottom.

In FIG. 3, different quantities of CO₂ (reference signs 36a-e) are shown, that each result in a different pressure (reference signs 40a-e, respectively). The time in seconds is depicted on the abscissa of the shown diagram, and the pressure in arbitrary units (a.u.) is depicted on the ordinate. As can be seen from the curve of the measured values, a relatively constant pressure prevails in the reaction vessel in the period of time between 0 and approximately 40 s. Then the sample is dosed into the reaction vessel. This event causes a strong increase in the following measured pressure value to a value between 60 a.u. and 120 a.u. Eventually the pressure drops again.

The sequence of pressure signals from the pressure sensor 39 is evaluated by means of the data processing unit 37 coupled to the pressure sensor 39. The sensor signals converted by the pressure sensor 39 and possibly amplified by an amplifier (not shown) are passed on to the data processing unit 37, possibly digitized. The data processing unit 37 comprises, for example, an averaging unit which forms a time average over at least some pressure signals of the sequence preceding the currently recorded pressure signal, for example, as a moving average value over all pressure signals recorded within a predetermined time window. Similarly, instead of a time window, a certain number of pressure signals preceding the current pressure signal in the sequence could be specified. The formation of the moving average value over at least a part of the pressure signals in the sequence preceding the current pressure signal in the sequence is comparable to a digital low-pass filter. Accordingly, other comparable filter functions can also be used. The time average value obtained in this way forms a base pressure value which corresponds to a base pressure prevailing in the reaction vessel 5. The temporal curve of the base pressure values forms a kind of “zero line” or “base line” of the pressure prevailing in reaction vessel 5. Pressure pulses due to the quantity of the sample transitioning into the gas phase lead to an increase in pressure beyond this base line.

Ideally, the base line runs substantially parallel to the abscissa of the diagram shown in FIG. 3. It is possible that, due to impurities in the sample gas stream, solid particles may accumulate which, over time, clog the filter unit 21. Both lead to a gradual increase in the base pressure in reaction vessel 5. This is shown in FIG. 6 with an arrow (near the bottom of the chart). To monitor the analytical apparatus 1, it is therefore possible to monitor the base pressure value by means of the data processing unit 37. For example, if the base pressure value exceeds a specified threshold, this may be an indication that the liquid sample is being dosed too quickly or that a clogged filter unit needs to be replaced. In this case, an alarm can be issued that triggers the implementation of a maintenance action.

In FIG. 4a, different quantities of CO₂ are shown (reference signs 36a-e). In FIG. 4a at the bottom, the measurements of the second flow sensor 41 are shown. At time 0, the sample is injected into oven 5. Due to the sudden evaporation of the aqueous sample, the flow rate increases sharply (regardless of the injected sample quantity – which is why the peak point shortly after time 0 is the same for all quantities). The low points in the flow rate at the second sensor 43 for the different CO₂ levels (reference signs 44a-e), on the other hand, comes from cooling. There is a larger water load in the air, which condenses again in the cooler. Here, the volume then contracts again, and there is a measurable low point (the water changes its aggregate state from gaseous to liquid, which increases the density of the water and decreases the volume; there is therefore no longer any water vapor in the gas phase, which decreases the volume flow at the outlet).

FIG. 4b shows a particular quantity of CO₂ (reference sign 36a). At the bottom, FIG. 4b shows the curve of the flow rate measurement at the two sensors 41 and 43. The flow rate is marked with the reference signs 42a and 44a.

Below the insert 9, within the reaction vessel 5, a further chamber 17 is arranged in which, during operation, a lower temperature already prevails than in the reaction zone. At the lower end of the reaction vessel 5, which is usually vertically oriented during operation and is opposite the injection nozzle 3, there is a gas outlet 19 which opens into the interior of a filter unit 21 so that a gas mixture generated in the reaction vessel 5 can flow into the filter unit 21 via the passage channels, the chamber 17 and the gas outlet 19 with the carrier gas. The filter unit 21 is connected to a condensation unit 25 via a gas line 23. The condensation unit 25 serves to separate water from the gas stream and is therefore optionally provided with a cooler to accelerate the condensation from the gas stream. The condensate is removed from the analytical apparatus 1 via a line 27.

An optional drying unit 31, a further filter 33, and the analysis chamber 35 are arranged in the flow direction of the gas stream behind the condensation unit 25. In the analysis chamber 35, the content is determined of reaction products of the analyte contained in the gas stream, for example, CO₂ and/or NOx. As a rule, to determine the CO₂ content, an infrared measuring apparatus, e.g., an infrared detector, is used. A chemiluminescence detector is usually used to determine the NOx content. The measurement signals recorded in the analysis chamber 35 are supplied to a data processing unit 37 with a computer, for example, a microcontroller or microprocessor, which determines the concentration of the analyte in the sample dosed into the reaction vessel 5 based on the measurement signals. The data processing unit 37 moreover controls the dosing apparatus 2 for dosing the liquid into the reaction vessel 5.

A quantity of a liquid sample dosed into the reaction vessel 5 via the injection nozzle 3 transitions into the gas phase almost immediately after entering the reaction zone, in particular by heat transfer in contact with a hot surface. If the liquid sample is an aqueous solution that contains oxidizable components in addition to water, the contained water, for example, transitions into gaseous H₂O by evaporation, while oxidizable components such as organic carbon- or nitrogen-containing compounds, react with the oxygen-containing carrier gas to form gaseous oxides such as CO₂ or NOx. This is noticeable by a pressure pulse or pressure surge within the reaction vessel 5, which can be recorded by the pressure sensor 39 arranged in the carrier gas supply line 7. This can also be recorded in the flow rate. The pressure surges 40a-e shown in FIG. 3 correspond to the flow rate curves shown in FIG. 4a (reference sign 44 a-e). Therefore, when a certain quantity of sample is injected, the pressure surge 40a and simultaneously a flow rate 44a etc. can be recorded.

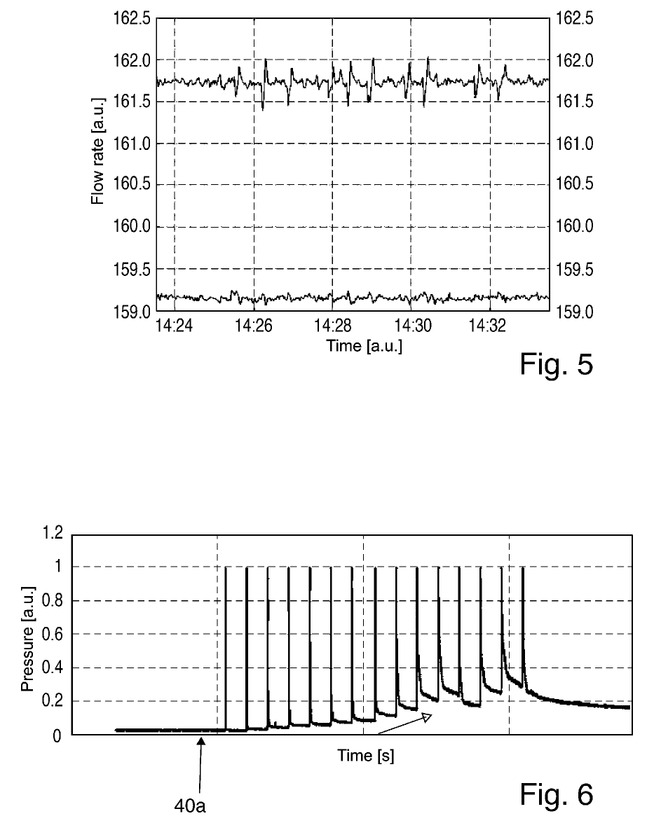

FIG. 5 shows the measured flow rate of the two flow rate sensors 41, 43. As mentioned, the first flow sensor 41 is located relatively “far forward” in the flow path of the carrier gas, the second flow sensor 43 is located relatively “far back.” If the difference between the measured values is too large, there must be a leak.

We claim:

1. An analytic apparatus for determining the concentration of an analyte in a liquid sample, wherein the analyte is an oxidizable component, the analytic apparatus comprising:
a dosing apparatus, including a pump, configured to dose the liquid sample into a high-temperature digestion apparatus, which is configured to digest the liquid sample, thereby forming a gas mixture, wherein the high-temperature digestion apparatus includes a reaction vessel with a liquid inlet for dosing the liquid sample and a gas supply line configured to supply a carrier gas, which is connected to an analysis chamber via a gas outlet,
wherein, during operation of the analytic apparatus, a gas stream of the carrier gas forms between the gas inlet and the analysis chamber,
wherein a pressure sensor is arranged upstream from the analysis chamber within the gas supply line in a direction of the gas stream,
wherein the pressure sensor is coupled to a control unit configured to further process the pressure signals output by the pressure sensor,
wherein a first flow rate sensor is arranged upstream from the analysis chamber in the direction of the gas stream,
wherein the first flow rate sensor is coupled to the control unit for further processing of the flow rate signals output by the first flow rate sensor, and
wherein a second flow rate sensor is arranged downstream from the analysis chamber in the direction of the gas stream,
wherein the second flow rate sensor is coupled to the control unit for further processing of the flow rate signals output by the second flow rate sensor.

2. The analytical apparatus according to claim 1, wherein the carrier gas is introduced continuously.

3. The analytical apparatus according to claim 1, wherein the liquid sample is dosed into the digestion apparatus in batches.

4. The analytical apparatus according to claim 3, wherein the liquid sample is dosed into the digestion apparatus every 5 to 10 minutes.

5. The analytical apparatus according to claim 1, wherein the first flow rate sensor is arranged within the gas supply line.

6. A method for determining a total organic carbon content of a liquid sample using an analytical apparatus according to claim 1.

7. The method according to claim 6, wherein a leak is inferred from the difference between the determined flows.

8. The method according to claim 6, wherein it is determined from the pressure signals whether any liquid sample reaches the digestion apparatus at all.

9. The method according to claim 6, wherein a quantity of the liquid sample is determined and controlled from the pressure signals, wherein incorrect dosing, including insufficient quantities of the liquid sample, are detected.

10. The method according to claim 6, wherein a base pressure value is determined from the pressure signals, and from a change in the base pressure value, a fault in the analytical apparatus is inferred.

11. The method according to claim 10, wherein a base pressure value is determined from the pressure signals by averaging over a certain period of time.

12. The method according to claim 10, wherein the inferred fault is inferred contamination.

13. The method according to claim 6, wherein an inference is made about a potential need for maintenance based on a pressure curve of the pressure signals and on a flow rate measurement curve of the flow rate signals.
